(19) United States
(12) Patent Application Publication
(10) Pub. No.: US 2002/0179775 A1
(43) Pub. Date: Dec. 5, 2002

(54) Spacecraft dependent on non-intrusive servicing

(76) Inventor: Andrew E. Turner, Mountain View, CA (US)

Correspondence Address: J. E. Kosinski, Loral Space & Communications, Ltd., Suite 303, 655 Deep Valley Drive, Rolling Hills Estates, CA, 90274, US

(21) Appl. No.: 09/845,370

(22) Filed: Apr. 30, 2001

(51) Int. Cl. B64G 1/00; B64G 1/22

(52) U.S. Cl. 244/158 R

(57) ABSTRACT

A spacecraft dependent on a non-intrusive servicing vehicle is provided. The spacecraft has a spacecraft body having at least one propellant tank and an actual orbit. The spacecraft body is located in an actual orbit and is adapted to be moved to an intended orbit. A payload is connected to the spacecraft body. A non-intrusive servicing interface is connected to the spacecraft. The servicing interface is adapted to repeatedly removably connect the spacecraft body to the non-intrusive servicing vehicle. The actual orbit of the spacecraft body is adjusted by the non-intrusive servicing vehicle and depends upon substantially periodic adjustments of the actual orbit by the non-intrusive servicing vehicle in order to maintain the parameters characterizing the actual orbit within dead bands specified for the intended orbit.

### BACKGROUND OF THE INVENTION

1. Field of the Invention

The present invention relates to a spacecraft and, more particularly, to a spacecraft dependent on non-intrusive servicing by a servicing vehicle.

2. Prior Art

A major impediment to the exploitation of the economic and scientific potential of orbiting spacecraft, such as for example telecommunications satellites, has been the size and weight limitations imposed on a given orbiting spacecraft's high value added payload. The high value added payload size and weight limit of a given orbiting spacecraft is constrained by propellant tank size within the orbiting spacecraft. The conventional approach has generally been to provide a full-lifetime propellant load for the orbiting spacecraft in order to allow the orbiting spacecraft to adjust its actual orbit in order to maintain the orbital parameters within the specified dead bands for the mission, an example of such a parameter would be to maintain inclination of less than or equal to 0.05 degrees on a typical geosynchronous spacecraft. When the orbital parameters are all within dead band, the spacecraft is within its intended orbit. As a result of this conventional approach, a typical geosynchronous (GEO) orbiting spacecraft is required to employ large 1000-liter, 49-inch diameter tanks for a full-lifetime propellant load. These large tanks in turn severely limit the high value added payload capacity of the orbiting spacecraft due to their size and weight.

Accordingly, there is a desire to increase the high value added payload weight and size capacity of orbiting spacecraft. The present invention overcomes the problems of the conventional approach as will be described in greater detail below.

### SUMMARY OF THE INVENTION

In accordance with a first embodiment of the present invention, a spacecraft dependent on non-intrusive servicing is provided. The spacecraft has a spacecraft body having at least one propellant tank and an actual orbit. The spacecraft body is located in an actual orbit and is adapted to be transferred to its intended orbit. A payload is connected to the spacecraft body. A non-intrusive servicing interface is connected to the spacecraft. The servicing interface is adapted to repeatedly removably connect the spacecraft body to the non-intrusive servicing vehicle. The actual orbit of the spacecraft body is adjusted by the non-intrusive servicing vehicle. The spacecraft body depends upon substantially periodic adjustments of the actual orbit by the non-intrusive servicing vehicle in order to make the actual orbit parameters lie within the dead bands specified for the intended orbit.

In accordance with a second embodiment of the present invention, a spacecraft dependent on non-intrusive servicing is provided. The spacecraft comprises a spacecraft body adapted to be placed in an orbit. The spacecraft body is further adapted to be coupled to a payload. A propellant container is coupled to the spacecraft body. The propellant container has a maximum propellant holding capacity and is adapted to contain a maximum propellant quantity sufficient for operation of the spacecraft for a period of time which is less than an expected total propellant quantity for an expected full life time of the spacecraft. A re-fueling interface is coupled to the propellant container. The propellant container is adapted to be re-fueled by the non-intrusive servicing vehicle at the re-fueling interface while the spacecraft body is in the orbit. The propellant container is adapted to be re-fueled by the same non-intrusive servicing vehicle at a substantially periodic interval of time.

In accordance with a third embodiment of the present invention, a spacecraft servicing system for servicing a plurality of spacecraft that have been placed in substantially similar orbits is provided. These spacecraft orbits may be sufficiently similar such that a spacecraft could transfer from the physical position of one spacecraft to the physical position of another spacecraft using a modest amount of propellant in a modest amount of time. Such amounts could be, for example, three kilograms of propellant and three days. The spacecraft servicing system comprises an orbiting depot having propellant and a non-intrusive servicing vehicle having a propellant container. The non-intrusive servicing vehicle is adapted to selectively transfer propellant from the orbiting depot to the propellant container. The non-intrusive servicing vehicle is adapted to either transfer propellant from the propellant container to the spacecraft or adjust the orbit of the spacecraft.

In accordance with a method of the present invention, a method of servicing spacecraft is provided comprising a step of placing a plurality of spacecraft in orbits. A non-intrusive servicing vehicle is provided. The non-intrusive servicing vehicle is adapted to re-fuel and/or adjust the orbits of the plurality of spacecraft. A step of re-fueling the plurality of spacecraft or adjusting the orbits of the plurality of spacecraft with the non-intrusive servicing vehicle at substanially periodic intervals of time while the plurality of spacecraft are in the orbits is then provided.

### BRIEF DESCRIPTION OF THE DRAWINGS

The foregoing aspects and other features of the present invention are explained in the following description, taken in connection with the accompanying drawings, wherein:

FIG. 1 is a schematic perspective view of an orbiting spacecraft servicing system incorporating features of the present invention;

FIG. 2A is a schematic perspective view of a prior art spacecraft;

FIG. 2B is a schematic perspective view of a spacecraft incorporating features of the present invention;

FIG. 3 is a schematic perspective view of a spacecraft incorporating features of the present invention;

FIG. 4 is a schematic perspective view of a non-intrusive servicing vehicle incorporating features of the present invention; and

### DETAILED DESCRIPTION OF THE PREFERRED EMBODIMENT

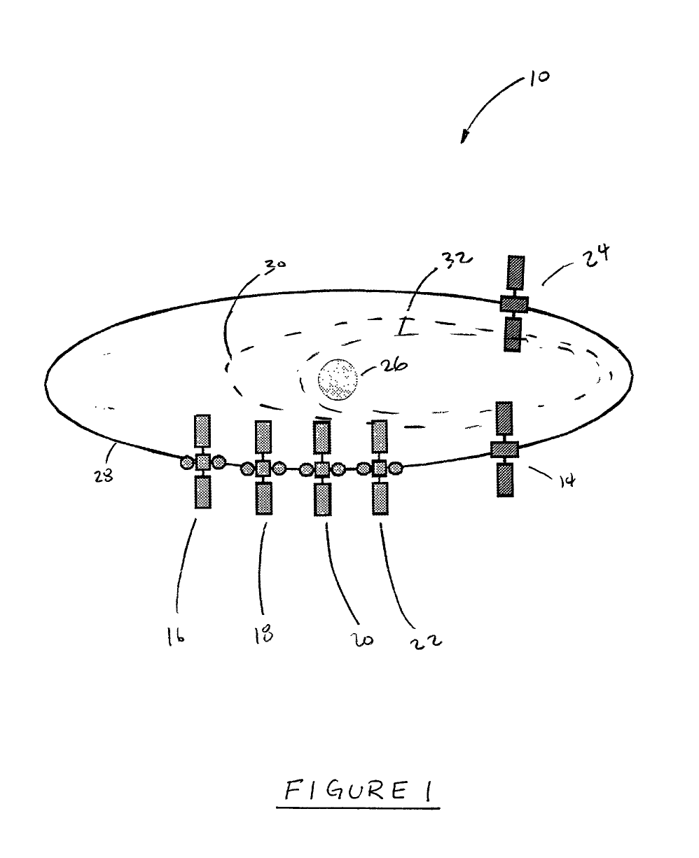

Referring to FIG. 1, there is shown a schematic perspective view of an orbiting spacecraft servicing system 10 incorporating features of the present invention. Although the present invention will be described with reference to the single embodiment shown in the drawings, it should be understood that the present invention can be embodied in many alternate forms of embodiments. In addition, any suitable size, shape or type of elements or materials could be used.

Orbiting spacecraft servicing system 10 generally comprises servicing vehicle 14, client spacecraft 16, 18, 20 and 22 and orbiting depot 24. Servicing vehicle 14, client spacecraft 16, 18, 20 and 22 and orbiting depot 24 are shown orbiting earth or body 26. Servicing spacecraft 14, client spacecraft 16, 18, 20 and 22 and orbiting depot 24 may have individual orbits that are congruent with orbit 28 or may involve orbital paths not congruent with orbit 28. Orbit 28 is shown as a substantially circular geosynchronous orbit (GEO), but may alternately be an elliptical orbit 30 or 32 or may alternately be another orbit about earth or body 26. Servicing vehicle 14 and orbiting depot 24 are adapted to service and support the 4 client spacecraft 16, 18, 20 and 22 as herein described but may alternately be adapted to support more or less than 4 client spacecraft. Servicing vehicle 14 is shown supported by a single orbiting depot 24 but may alternately be supported by more than one orbiting depot. Although only a single servicing vehicle 14 is shown, multiple servicing vehicles may be used to interchangeably support multiple client spacecraft.

Orbiting Depot 24 may be placed in orbit by a Launch Vehicle. Orbiting depot 24 may be placed in a substantially circular geosynchronous orbit (GEO) or alternately another orbit. Orbiting depot 24 has large propellant tanks, sufficient to support a single or multiple re-fuelings of the servicing vehicle. Orbiting depot 24 may be re-supplied by subsequent launch vehicles and/or replaced upon depletion of its propellant supply.

The servicing vehicle 14 may have multiple large propellant tanks, such as 1000-liter 49-inch diameter tanks. The servicing vehicle 14 may have the capacity for enough propellant to participate in the process of achieving GEO. The servicing vehicle has the capacity for enough propellant to participate in significant maneuvers to support each of the client spacecraft multiple times and in a re-usable manner.

The servicing vehicle 14 is first inserted into a transfer orbit (GTO), typically by a launch vehicle (LV) from which it can reach GEO using a quantity of propellant, about 1000 kg of propellant or more. The servicing vehicle 14 then transfers from GTO to GEO using its own propellant. Alternately, the servicing vehicle 14 is first inserted directly into or close to GEO, typically by a launch vehicle (LV). The servicing vehicle 14 then transfers to its own GEO using its own propellant. The servicing vehicle 14 may selectively maneuver between the 4 client spacecraft 16, 18, 20 and 22 and the orbiting depot 24.

The client spacecraft 16, 18, 20 and 22 have either no propellant tanks or small propellant tanks, but would not include large 1000-liter 49-inch diameter tanks like existing geosynchronous (GEO) spacecraft. As a result, these client spacecraft do not have enough propellant to provide a major fraction of the propellant expended in the process of achieving GEO, and depend on either a launch vehicle and/or another external vehicle, such as the servicing vehicle 14 to reach their own GEO.

The client spacecraft 16, 18, 20 and 22 may be inserted directly into GEO using a launch vehicle (LV) that has the capability to inject significant spacecraft mass directly into GEO. The LV takes a client spacecraft directly to or close to GEO and separates it there. Each client spacecraft may be injected into a near-circular orbit very near GEO where a small quantity, about 10 kg or less, of propellant is needed for injection into GEO. This injection could be assisted by the servicing vehicle as follows. The servicing vehicle adjusts its orbit, docks with the client spacecraft and acts as a space tug to transfer the client spacecraft to GEO. This eliminates the need for apogee maneuvering firing (AMF) or any major orbit raising activity by each of the client spacecraft. As a result, large client spacecraft tanks are reduced or eliminated from the client spacecraft, thus freeing up considerable volume within the client spacecraft for various uses, including extending the payload from the earth deck toward the anti-earth panel. The need to design the client spacecraft structure to handle the coupled loads from large quantities of fluid within the launch environment is eliminated resulting in lower cost and reduced weight. Deployments and other client spacecraft operations take place in GEO, eliminating outages during Geosynchronous Transfer Orbit (GTO) perigee crossings and the need for the client spacecraft's earth sensor to operate with an earth of variable apparent size. These advantages, that translate into reduced cost, schedule, complexity and spacecraft development risk, are traded against the significant loss in spacecraft mass capability at beginning of life for each LV for GEO direct insertion of client spacecraft.

An alternative to the client spacecraft 16, 18, 20 and 22 being inserted directly into GEO is provided by first inserting each client spacecraft into a transfer orbit from which it can reach GEO using a quantity of propellant, about 1000 kg of propellant or more. This transfer orbit is known as a geosynchronous transfer orbit (GTO) and has apogee or maximum altitude at about the same altitude as GEO and perigee or minimum altitude typically at an altitude of about 200 km. As a result, GTO is a lot easier for a launch vehicle to reach when ferrying each of the client spacecraft as compared to a GEO direct insertion of the client spacecraft. GTO is highly eccentric or elliptical. Once the client spacecraft is inserted into GTO, the servicing vehicle 14 lowers its orbit all the way down to GTO and acts as a space tug to transfer each client spacecraft from GTO to GEO. This eliminates the need for apogee maneuvering firing (AMF) or any major orbit raising activity by each of the client spacecraft alone. As a result, large spacecraft tanks are eliminated from the client spacecraft, thus freeing up considerable volume within the client spacecraft for various uses, including extending the payload from the earth deck toward the anti-earth panel. The need to design the client spacecraft structure to handle the coupled loads from large quantities of fluid within the launch environment is also eliminated resulting in lower cost and reduced weight. These advantages translate into reduced cost, schedule, complexity and spacecraft development risk.

The servicing vehicle 14 is capable of acting as a space tug for captive-carry through maneuvers and/or as a short-term/just-in-time propellant supplier for maneuvers for each of the client spacecraft to be serviced. The servicing vehicle 14 re-usably supports the client spacecraft without either the client spacecraft or the servicing vehicle 14 being manned. Both the servicing spacecraft 14 and the client spacecraft are un-manned. The servicing vehicle 14 is capable of re-fueling at orbiting depot 24 in order to re-usably support the propellant requirements of servicing multiple client spacecraft. The servicing vehicle 14 is capable of supporting each of the client spacecraft for all significant maneuvers such as atmospheric drag compensation for low earth orbits (LEO), orbit raising maneuvers and north-south station keeping or east-west stationkeeping in geosynchronous orbits (GEO) and attitude control. The servicing vehicle 14 rendezvous and docks with each of the client spacecraft for a few hours each week or each month as appropriate, and may be capable of servicing a dozen or so spacecraft. The servicing vehicle 14 does not perform intrusive servicing, such as equipment change-out or repair. Instead, servicing is limited to non-intrusive activities such as refueling, captive-carry through orbit adjust maneuvers, power transfer to the client spacecraft for battery re-conditioning, operational monitoring, and deployment of stowed equipment. Examples of deployment of stowed equipment include deployment of solar arrays, antenna reflectors, magnetometer booms, solar radiation covers or shields. The client spacecraft being serviced would be entirely dependent upon a servicing vehicle 14 for frequent support in at least some of these activities to perform its mission. The launch mass and therefore cost of the client spacecraft is reduced since it need not carry all propellant for a lifetime. Because it need not carry all propellant for a lifetime, the design of the client spacecraft is simplified resulting in additional available volume at the geometrical center of the client spacecraft body which may be used for high value added payloads or other equipment eliminating the need for group payload equipment near the earth deck or other outer decks of the client spacecraft.

Table 1 summarizes the cost benefit associated with one non-intrusive servicing operational scenario according to the present invention.

TABLE 1

| Consideration | Client Spacecraft | Servicing Vehicle |
|---|---|---|
| Mode of servicing | Non-Intrusive. No materials | Acts as a space tugboat, may |
| | exchanged | transfer power and signal, |
| | | assists with deployments |
| Frequency of servicing | Monthly | Shuttles between twelve |
| | | clients, services 1 client every |
| | | 2-3 days |
| External fluid re-supply | None, no fluids resupplied | Obtains propellant from orbiting |
| | | depot. Depot resupplied with |
| | | propellant carried by Aquarius |
| | | or other low cost launch |
| | | vehicles and ferried to GEO by |
| | | appropriate means, e.g. Orbital |
| | | Transfer Vehicles |
| North-South Stationkeeping | Does not perform | Supports client. |
| East-West Stationkeeping | Cold-gas | Does not support client |
| Attitude control | Cold-gas, no momentum or | Momentum wheels, bi- |
| | reaction wheels | propellant, takes over attitude |
| | | control of client when docked |
| Orbit raising | Early spacecraft carried directly | Same as client spacecraft |
| | to GEO by new large | |
| | launchers. Later spacecraft | |
| | carried to LEO by launcher and | |
| | ferried to GEO by Orbital | |
| | Transfer Vehicles | |
| Internal configuration | No large tanks, volume | No communications payload |
| | available for thermal control | includes large tanks for |
| | also to minimize spacecraft | maneuvers. |
| | dimensions | |
| Cost relative to current GEO | Lower, plus shorter schedule | Lower, no comm payload |

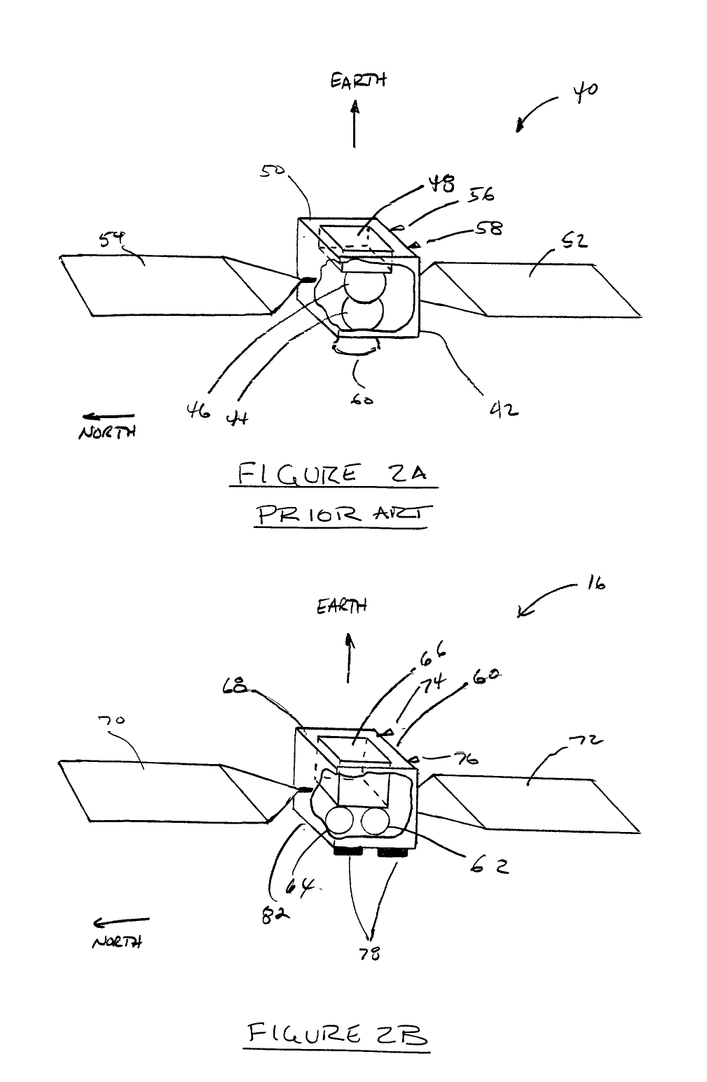

Referring now to FIG. 2A, there is shown a prior art spacecraft 40. Prior art spacecraft 40 has a spacecraft body 42, and at least one propellant tank 44, 46. The spacecraft body is adapted to be coupled to a payload 48, typically on or adjacent to the earth face 50 of spacecraft body 42. Payload 48 may be equipment for communications or imaging or other purposes typically found in orbiting unmanned spacecraft. The size of payload 48 is constrained principally by the size of propellant tanks 44 and 46. Solar arrays 52 and 54 provide power to batteries which in turn may support controllers, attitude and orbital control, momentum wheels, communications and other power based functions typical of unmanned spacecraft. Thrusters 56, 58 and 60 provide thrust for all major maneuvers including north south station keeping, east west station keeping, attitude control and orbit raising. Thrusters 56, 58 and 60 are supplied propellant from propellant tanks 44 and 46. The propellant may be cold gas such as pressurized helium or nitrogen or monopropellant hydrazine or other propellant sufficient for spacecraft propulsion. Propellant Tanks 44 and 46 provide propellant sufficient for the lifetime of the spacecraft 40. The size of propellant tanks 44 and 46 as a result is constrained by the expected propellant consumption over the lifetime of the spacecraft which in turn limits the volume and mass available for the high value added payload 48 that may be coupled to spacecraft 40.

Referring now to FIG. 2B, there is shown a client spacecraft 16, typical of client spacecraft 16, 18, 20 and 22, according to one embodiment of the present invention. Client spacecraft 16 has a spacecraft body 60, and at least one propellant tank 62, 64. The spacecraft body is adapted to be coupled to a payload 66, typically on or adjacent to the earth face 68 of spacecraft body 60. Payload 66 may be equipment for communications or imaging or other purposes typically found in orbiting unmanned spacecraft. The size of payload 66 is constrained principally by the size of propellant tanks 62 and 64. Solar arrays 70 and 72 may provide power to batteries which in turn may support controllers, attitude and orbital control, momentum wheels, communications and other power based functions typical of unmanned spacecraft. Thrusters 74, and 76 may provide thrust for minor maneuvers including minor north south station keeping, minor east west station keeping, and attitude control. Thrusters may be propellant based thrusters, electric thrusters or other types of thrusters. Thrusters 74 and 76 are supplied propellant from propellant tanks 62 and 64. The propellant may be cold gas or monopropellant hydrazine and may be accompanied by electrical power for electric thrusters or other propellant sufficient for spacecraft propulsion. In an alternate embodiment where client spacecraft 16 would rely on servicing vehicle for substantially all significant maneuvers, thrusters 74 and 76 may not be provided. In a further alternate embodiment where client spacecraft 16 would rely on servicing vehicle for substantially all significant maneuvers, thrusters 74 and 76 may be provided for attitude control or for minor station keeping and used in conjunction with momentum wheels for attitude control, or momentum wheels may not be included on the spacecraft at all where momentum control is performed by the thrusters. Propellant Tanks 62 and 64 need not provide propellant sufficient for the lifetime of the spacecraft 16 as is required by the prior art spacecraft 40. The size of propellant tanks 62 and 64 is constrained by the expected propellant consumption over the period of time where the servicing vehicle 14 is not available to support client spacecraft 16, not by the lifetime of spacecraft 16 as in prior art spacecraft 40. This in turn increases the volume and mass available for the high value added payload 66 that may be coupled to spacecraft 16 as compared to prior art spacecraft 40. Client spacecraft has interfaces 78 shown located on the anti earth panel 82. Although interfaces 78 are shown located on the anti earth panel 82, they may alternately be located on any suitable panel or location. Interfaces 78 are adapted to re-usably interface with the servicing spacecraft 14 to enable the non-intrusive servicing and captive-carry maneuvers by the servicing vehicle 14. Interface 78 may actually be a single interface point or multiple interface points.

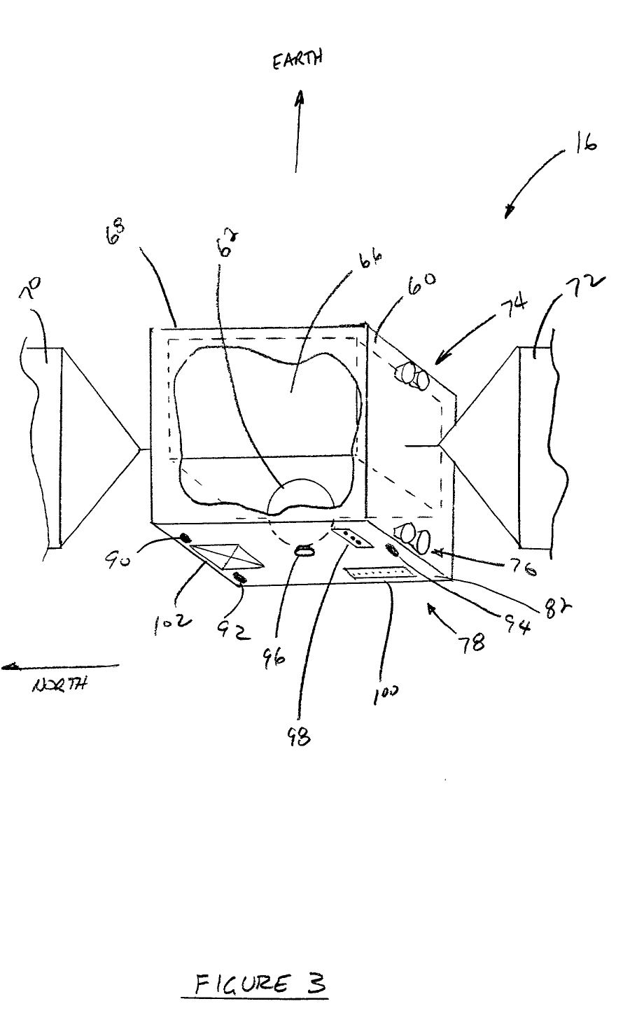

Referring now to FIG. 3 is a schematic perspective view of a client spacecraft 16 incorporating features of the present invention. Client spacecraft 16 has a spacecraft body 60, and at least one propellant tank 62. The spacecraft body is coupled to a payload 66 on the earth side 68 of spacecraft body 42. Solar arrays 70 and 72 are provided. Thrusters 74, and 76 may be provided. Client spacecraft 14 has interfaces 78 shown located on the anti earth panel 82. Interfaces 78 may comprise coupling points 90, 92 and 94, propellant interface 96, power interface 98, data communication interface 100 and/or stowed equipment deployment interface 102. Interfaces 78 are adapted to re-usably interface with the servicing vehicle 14 to enable the non-intrusive servicing and captive-carry maneuvers by the servicing vehicle 14. Although interfaces 78 are shown located on the anti earth panel 82, any or all of the interfaces 78 may be located on one or more other panels or locations relative to client spacecraft 16. Although interfaces 78 are broken down as shown, more or less interfaces between the client spacecraft 16 and the servicing vehicle 14 may be provided.

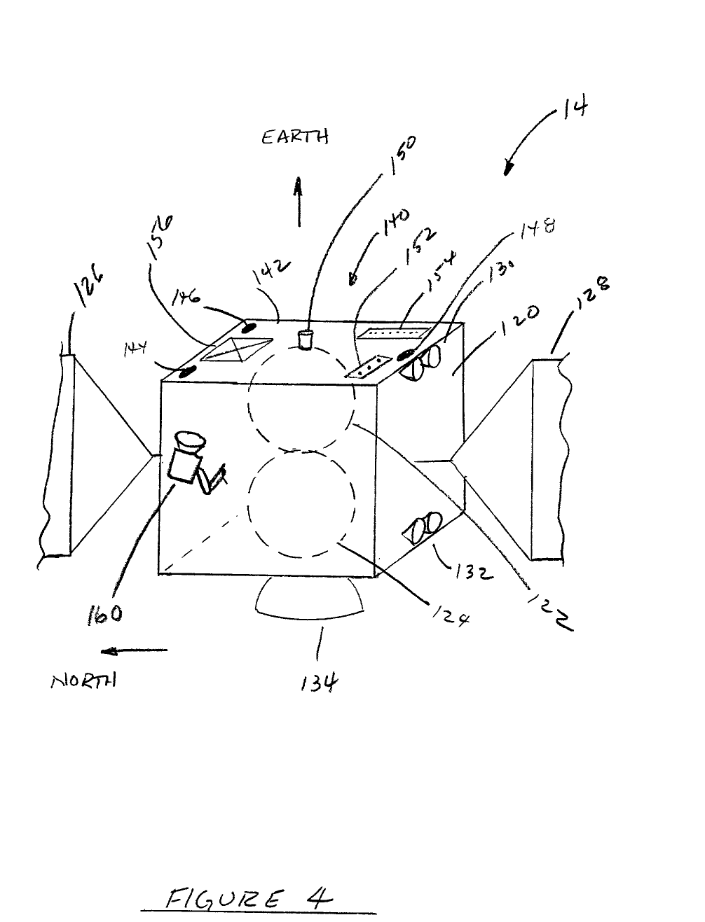

Referring also to FIG. 4 is a schematic perspective view of a servicing vehicle 14 incorporating features of the present invention. Servicing vehicle 14 has a spacecraft body 120, and at least one propellant tank 122, 124. Servicing vehicle 14 is re-usably adapted for non-intrusive servicing of client spacecraft, and as a result, may utilize a large portion of its payload capability for propellant storage and/or stowed equipment deployment storage and/or other non-intrusive service related equipment storage. Solar arrays 126 and 128 are provided. Thrusters 130, 132 and 134 are provided. In an alternate embodiment, one or more thrusters used in combination with momentum wheels may be provided. Thrusters 130, 132 and 134 may be propellant based thrusters, electric thrusters or propulsion devices otherwise. Thrusters 130, 132 and 134 may be supplied propellant from propellant tanks 122 and 124. The propellant may be cold gas or propellant such as monopropellant hydrazine and may involve electrical power for electric thrusters or other propellant sufficient for spacecraft propulsion. The servicing vehicle 14 utilizes thrusters 130, 132 and 134 to support each of the client spacecraft while it is docked with the client spacecraft for any or all significant maneuvers such as atmospheric drag compensation for low earth orbits (LEO), orbit raising maneuvers and north-south station keeping or east-west stationkeeping in geosynchronous orbits (GEO) and attitude control while the client spacecraft is docked to the servicing vehicle 14. The servicing vehicle 14 may also reposition and/or reorient the client spacecraft 16 as required while docked. Repositioning and/or reorienting may be for the purposes of testing or other purposes such as antenna pattern characterizing as part of In Orbit Testing (IOT) or other IOT such as imaging mapping or other payload pattern mapping and characterizing or other wise. Where the servicing vehicle 14 is utilized, momentum wheels may not be included on the client spacecraft 16 at all where momentum control is performed by the thrusters on client spacecraft 16 or where the client spacecraft 16 relies on the servicing vehicle 14 for attitude control. Servicing vehicle 14 has interfaces 140 shown located on the earth side panel 142. Interfaces 140 may comprise coupling points 144, 146 and 148, propellant interface 150, power interface 152, data communication interface 154 and/or stowed equipment deployment interface 156. Imaging equipment 160 may be included to visually inspect the client spacecraft 16. Interfaces 140 are adapted to re-usably interface with the client spacecraft 16, 18, 20 and 22 to selectively enable the non-intrusive servicing and captive-carry maneuvers by the servicing vehicle 14. Interfaces 140 is adapted to interface with interface 78 of the client spacecraft 16. Interfaces 140 may also be adapted to re-usably interface with the orbiting depot 24 for re-fueling and servicing the servicing vehicle in order to re-usably support the propellant and non-intrusive servicing requirements of servicing multiple client spacecraft. In an alternate embodiment, a separate interface, in whole or in part, may be provided to allow the servicing vehicle 14 to interface with the orbiting depot 24. Although interfaces 140 are shown located on the earth side panel 142, any or all of the interfaces 140 may be located on one or more other panels or locations relative to servicing vehicle 14. Although interfaces 140 are broken down as shown, more or less interfaces between the servicing spacecraft 14 and the client spacecraft 16 may be provided. Imaging equipment 160 are included to visually inspect the client spacecraft 16.

Coupling points 90, 92 and 94 of client spacecraft 16 are adapted to re-usably interface and couple with the coupling points 144, 146 and 148 respectively of servicing vehicle 14 to enable the captive-carry maneuvers by the servicing vehicle 14. The coupling points may also be used to allow client spacecraft 16 to dock with servicing vehicle 14 during other non-intrusive servicing activities. In an alternate embodiment, client spacecraft 16 would not couple with servicing vehicle 14 during other non-intrusive servicing activities. The coupling points 90, 92 and 94 may selectively be coupled or de-coupled from coupling points 144, 146 and 148 respectively such as by a ball and socket arrangement where the socket may be articulated to selectively latch to the ball or release from the ball. In an alternate embodiment, any suitable coupling may be used to rigidly or semi rigidly couple servicing vehicle 14 to client spacecraft 16. Although three coupling points are shown, more or less coupling points may be provided.

Propellant interface 96 of the client spacecraft 16 is adapted to re-usably interface with the propellant interface 150 of the servicing vehicle 14 to enable the non-intrusive servicing related to propellant transfer from the servicing vehicle 14 to the client spacecraft 16. In the embodiment shown, propellant interface 96 is coupled to tank 62 and propellant interface 150 is coupled to tank 122. Propellant interface 96 may be adapted to re-usably couple with the propellant interface 150 and to make a positive seal to prevent leakage of propellant. In one embodiment, propellant interface 96 and 150 may be adapted to transfer propellant such as the monopropellant hydrazine. In an alternate embodiment, propellant interface 96 and 150 may be adapted to transfer any type of propellant, fuel or power suitable for use by the client spacecraft 16.

Power interface 98 of the client spacecraft 16 is adapted to re-usably interface with the power interface 152 of the servicing vehicle 14 to enable the non-intrusive servicing related to power transfer from the servicing vehicle 14. In typical operation, power may be transferred to the client spacecraft 16 for battery re-conditioning, battery charging or simple power up in the case of the client spacecraft 16 not having a working battery on board, may not have a battery on board or may not have sufficient battery capacity on board for startup or otherwise. Power interface 98 and 152 may comprise electrical contacts allowing power such as electricity to pass through the electrically conductive contacts. In alternative embodiments, power may be transferred inductively, optically or otherwise.

Imaging equipment 160 is used to visually inspect client spacecraft 16 to monitor its condition. Imaging equipment 160 may incorporate a camera, such as a CCD camera, memory to store images or image streams and a data transmission device to transmit the images to be viewed and analyzed. Imaging equipment 160 may further include a actuator driven mount or linkage to allow the attitude and/or the position of the camera to be changed relative to servicing vehicle 14 while docked with client spacecraft 16 or otherwise. Although imaging equipment 160 is shown as a single imaging source or interface, more or less such interfaces may be provided in alternate locations.

Data communication interface 100 of the client spacecraft is adapted to re-usably interface with data communication interface 154 the servicing vehicle 14 to enable communication with the servicing vehicle 14. In typical operation, data may be transferred to or from the client spacecraft 16 for operational monitoring, data down load or data upload to or from the client spacecraft. Data communication interfaces 100 and 154 may comprise electrical contacts allowing signals such as digital or analog electrical signals to pass through the electrically conductive contacts. In alternative embodiments, data may be transferred inductively, optically or otherwise. Data transfer may alternately take place when the servicing vehicle 14 and the client spacecraft 16 are physically separated by a large or short distance. Such a modest short distance could be, for example, approximately 100 meters. Although data communication interface 100 and data communication interface 154 are shown as a single interface, more or less such interfaces may be provided. Such an additional interface may include, for example, a communication interface for communicating data or otherwise with other spacecraft or earth and base control communications as in prior art spacecraft.

Stowed equipment deployment interface 102 of the client spacecraft 16 is adapted to re-usably interface with the stowed equipment deployment interface 156 of the servicing vehicle 14 to enable the non-intrusive servicing associated with the deployment of stowed equipment. The stowed equipment that may be deployed may include solar arrays, magnetometer booms, solar radiation covers or shields, deployable radiators, antenna reflectors or other equipment that may be stowed on client spacecraft 16. Although one stowed equipment deployment interface 102 is shown, there may be more or less stowed equipment deployment interfaces. Although one stowed equipment deployment interface 156 is shown, there may be more or less stowed equipment deployment interfaces. Deployment of stowed equipment typically consists of no material being exchanged between the client spacecraft 16 and the servicing vehicle 14. Servicing vehicle 14 provides electrical power and/or torque and/or force to assist with the mechanical motion and mechanical power required drive the mechanisms and linkages associated with the deployment of stowed equipment on client spacecraft 16. The deployment may be monitored using imaging equipment 160. The use of the stowed equipment deployment interface enables the client spacecraft 16 to reduce the cost, volume and mass associated with deployment actuators that would have been on board client spacecraft 16 were there no reliance on servicing vehicle 14.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A spacecraft dependent on a non-intrusive servicing vehicle, the spacecraft comprising:
a spacecraft body having at least one propellant tank and an actual orbit, the spacecraft body being located in an actual orbit and being adapted to be moved to an intended orbit;
a payload connected to the spacecraft body; and
a non-intrusive servicing interface connected to the spacecraft, the servicing interface being adapted to repeatedly removably connect the spacecraft body to the non-intrusive servicing vehicle;
wherein the actual orbit of the spacecraft body is adapted to be adjusted by the non-intrusive servicing vehicle and wherein the spacecraft body depends upon substantially periodic adjustments of the actual orbit by the non-intrusive servicing vehicle in order to track the intended orbit.

2. The spacecraft of claim 1 further comprising a cold-gas or chemical propulsion system coupled to the spacecraft body, wherein the cold-gas or chemical propulsion system is used to partially correct drift from the intended orbit of the spacecraft body.

3. The spacecraft of claim 1 further comprising an electric propulsion system coupled to the spacecraft body, wherein the electric propulsion system is used to partially correct drift from the intended orbit of the spacecraft body.

4. The spacecraft of claim 1 wherein the spacecraft body utilizes the non-intrusive servicing vehicle as a tug to correct north-south drift from the intended orbit of the spacecraft body.

5. The spacecraft of claim 1 wherein the spacecraft body utilizes the non-intrusive servicing vehicle as a tug to correct drift from the intended orbit as a result of atmospheric drag on the spacecraft body.

6. The spacecraft of claim 1 further comprising stowed equipment coupled to the spacecraft body, wherein the non-intrusive servicing vehicle is used as a source of torque or force to deploy the stowed equipment.

7. The spacecraft of claim 1 wherein the spacecraft body utilizes the non-intrusive servicing vehicle as a tug to reorient and/or reposition the spacecraft body to characterize or map the pattern of an antenna or the payload coupled to the spacecraft body.

8. A spacecraft dependent on a non-intrusive servicing vehicle, the spacecraft comprising:
a spacecraft body adapted to be placed in an orbit, the spacecraft body further adapted to be coupled to a payload;
a propellant container coupled to the spacecraft body, the propellant container having a maximum propellant holding capacity and adapted to contain a maximum propellant quantity sufficient for operation of the spacecraft for a period of time which is less than an expected total propellant quantity for an expected full life time of the spacecraft; and
a re-fueling interface coupled to the propellant container;
wherein the propellant container is adapted to be re-fueled by the non-intrusive servicing vehicle at the re-fueling interface while the spacecraft body is in the orbit and wherein the propellant container is adapted to be re-fueled by the same non-intrusive servicing vehicle at a substantially periodic interval of time.

9. The spacecraft of claim 3 wherein the maximum propellant quantity is less than 500 liters.

10. The spacecraft of claim 8 wherein the maximum propellant quantity is less than 250 liters.

11. The spacecraft of claim 8 wherein the propellant container is a battery adapted to contain electric power.

12. The spacecraft of claim 8 wherein the propellant container is a tank adapted to contain monopropellant hydrazine.

13. The spacecraft of claim 8 further comprising stowed equipment coupled to the spacecraft body, wherein the non-intrusive servicing vehicle is used as a source of torque or force to deploy the stowed equipment.

14. The spacecraft of claim 8 wherein the spacecraft body utilizes the non-intrusive servicing vehicle as a tug to reorient and/or reposition the spacecraft body to characterize or map the pattern of an antenna or the payload coupled to the spacecraft body.

15. A spacecraft servicing system for servicing a plurality of spacecraft that have been placed in orbits, the spacecraft servicing system comprising:
an orbiting depot having propellant; and
a non-intrusive servicing vehicle having a propellant container;
wherein the non-intrusive servicing vehicle is adapted to selectively transfer propellant from the orbiting depot to the propellant container and wherein the non-intrusive servicing vehicle is adapted to either transfer propellant from the propellant container to the spacecraft or adjust the orbit of the spacecraft.

16. The spacecraft servicing system of claim 15 wherein the non-intrusive servicing vehicle acts as a tug to adjust the orbit of the spacecraft.

17. The spacecraft servicing system of claim 15 wherein the non-intrusive servicing vehicle is further adapted to recondition a battery of the spacecraft.

18. The spacecraft servicing system of claim 15 wherein the non-intrusive servicing vehicle is adapted to both transfer propellant from the propellant container to the spacecraft and adjust the orbit of the spacecraft.

19. The spacecraft servicing system of claim 15 wherein the non-intrusive servicing vehicle is further adapted to perform operational monitoring of the spacecraft.

20. The spacecraft servicing system of claim 15 wherein the non-intrusive servicing vehicle is used as a source of torque or force to deploy stowed equipment on the spacecraft.

21. The spacecraft servicing system of claim 15 wherein the spacecraft utilizes the non-intrusive servicing vehicle as a tug to reorient and/or reposition the spacecraft body to characterize or map the pattern of an antenna or a payload coupled to the spacecraft body.

22. A method of servicing spacecraft comprising:
placing a plurality of spacecraft in orbits;
providing a non-intrusive servicing vehicle adapted to re-fuel and/or adjust the orbits of the plurality of spacecraft; and
re-fueling the plurality of spacecraft or adjusting the orbits of the plurality of spacecraft with the non-intrusive servicing vehicle at substanially periodic intervals of time while the plurality of spacecraft are in the orbits.

23. The method of servicing spacecraft of claim 22 wherein the step of placing a plurality of spacecraft in orbits comprises directly inserting each spacecraft into geosynchronous orbit.

24. The method of servicing spacecraft of claim 22 wherein the step of adjusting the orbits of the plurality of spacecraft with the non-intrusive servicing vehicle comprises the steps of coupling the non-intrusive servicing vehicle to each spacecraft and tugging each spacecraft with the non-intrusive servicing vehicle.

25. The method of servicing spacecraft of claim 22 further comprising the step of performing operational monitoring of each spacecraft with the non-intrusive servicing vehicle.

26. The method of servicing spacecraft of claim 22 further comprising the step of reconditioning a battery of each spacecraft with the non-intrusive servicing vehicle.

27. The method of servicing spacecraft of claim 22 further comprising the step of deploying stowed equipment on the spacecraft with torque or force from the non-intrusive servicing vehicle.

28. The method of servicing spacecraft of claim 22 further comprising the step of reorienting and/or repositioning the spacecraft body with the non-intrusive servicing vehicle to characterize or map the pattern of an antenna.
